(19) United States
(12) Patent Application Publication
(10) Pub. No.: US 2026/0260063 A1
(43) Pub. Date: Sep. 3, 2026

(54) METHODS AND SYSTEMS FOR PRE-PROCESSING INPUTS TO A LARGE LANGUAGE MODEL FOR REDUCING TOKEN SIZE

(71) Applicant: Ciena Corporation, Hanover, MD (US)

(72) Inventors: Anurag Prakash, Ottawa (CA); Maryam Ekhlasi, Montreal (CA); Prince Kapoor, Kanata (CA)

(21) Appl. No.: 19/066,440

(22) Filed: Feb. 28, 2025

(51) Int. Cl. G06F 40/284; H04L 43/04

(52) U.S. Cl. CPC G06F 40/284; H04L 43/04

(57) ABSTRACT

A method and system for pre-processing input to a large language model to reduce token size, the method including receiving logs from a network or network element, collapsing the logs in space by grouping repeated or similar sequences of logs into clusters with one representative log identified per cluster, collapsing the logs in time by organizing the representative logs in temporal sequence and identifying representative logs within a predetermined time window to be of a same sequence, and providing the representative logs of different sequences to the large language model with an indication of their temporal sequence to minimize token size. The method further includes parsing the representative logs of the different sequences at the large language model to identify an issue with the network or network element and controlling operation of the network or network element responsive to the identified issue.

### TECHNICAL FIELD

The present disclosure relates generally to methods and systems for pre-processing inputs to a large language model (LLM) for reducing token size utilizing a flame graph approach.

### BACKGROUND

Identifying problems using network and device logs is often time-consuming and costly for developers. Although using LLMs can help automate this process, challenges such as resource limitations and frequent the need to retrain the LLMs due to the dynamic nature of complex software and the associated logs remain. Although using external LLMs, such as generative pre-trained transformers (GPTs), and in-context learning techniques can assuage these issues to some extent, other challenges exist, such as token limitations, cost per token call, and data privacy.

The present background is provided as illustrative environmental context only. It will be readily apparent to those of ordinary skill in the art that the concepts and principles of the present disclosure may be implemented in other environmental contexts equally, without limitation.

### SUMMARY

The present disclosure addresses the above issues by providing an automated pipeline that extracts log files and uses in-context learning to adapt an LLM model without extensive retraining. The present disclosure also provides an advantageous approach to accurately responding to developer queries, helping them quickly pinpoint issues within log files while keeping token usage and computational costs manageable. This method enables industries to automate log analysis, reduce system downtime, and improve performance, all while ensuring data privacy and operational efficiency.

In some embodiments, the present disclosure provides a method for pre-processing input to a large language model to reduce token size, the method including receiving logs from a network or network element, collapsing the logs in space by grouping repeated or similar sequences of logs into clusters with one representative log identified per cluster, collapsing the logs in time by organizing the representative logs in temporal sequence and identifying representative logs within a predetermined time window to be of a same sequence, and providing the representative logs of different sequences to the large language model with an indication of their temporal sequence to minimize token size. The method further includes parsing the logs for timestamp and message prior to collapsing the logs in space and collapsing the logs in time. In some embodiments, collapsing the logs in space includes, based on the parsed messages of the logs, applying a cosine similarity algorithm to the logs to create a cosine similarity map of the logs and collapsing the logs in time includes, based on the parsed timestamps of the logs, creating a time window based forest graph of the logs where each graph component is a directed acyclic graph. The method further includes, given the time window based forest graph, converting each graph component tree to a sequence that can be understood by the large language model. The method further includes replacing each message with an associated group number obtained from the cosine similarity map. The method further includes recording beginning and end timestamps of each different sequence to provide a time window view of events in the network or network element. The method further includes merging directed trees and occurrence counts. In some embodiments, the method further includes organizing a query to the large language model prior to providing the representative logs of the different sequences to the large language model by adding additional qualifiers to individual directed trees and recorded time windows. The method further includes parsing the representative logs of the different sequences at the large language model to identify an issue with the network or network element and controlling operation of the network or network element responsive to the identified issue.

In some embodiments, the present disclosure provides a non-transitory computer-readable medium including instructions stored in a memory and executed by a processor to carry out a method for pre-processing input to a large language model to reduce token size, the method including receiving logs from a network or network element, collapsing the logs in space by grouping repeated or similar sequences of logs into clusters with one representative log identified per cluster, collapsing the logs in time by organizing the representative logs in temporal sequence and identifying representative logs within a predetermined time window to be of a same sequence, and providing the representative logs of different sequences to the large language model with an indication of their temporal sequence to minimize token size. The method further includes parsing the representative logs of the different sequences at the large language model to identify an issue with the network or network element and controlling operation of the network or network element responsive to the identified issue.

In some embodiments, the present disclosure provides a system for pre-processing input to a large language model to reduce token size, the system including a network or network element and a memory storing instructions executed by a processor to receive logs from the network or network element via a network interface, collapse the logs in space by grouping repeated or similar sequences of logs into clusters with one representative log identified per cluster, collapse the logs in time by organizing the representative logs in temporal sequence and identifying representative logs within a predetermined time window to be of a same sequence, and provide the representative logs of different sequences to the large language model with an indication of their temporal sequence to minimize token size. The instructions are further executed by the processor to parse the logs for timestamp and message prior to collapsing the logs in space and collapsing the logs in time. In some embodiments, collapsing the logs in space includes, based on the parsed messages of the logs, applying a cosine similarity algorithm to the logs to create a cosine similarity map of the logs and collapsing the logs in time includes, based on the parsed timestamps of the logs, creating a time window based forest graph of the logs where each graph component is a directed acyclic graph. The instructions are further executed by the processor to, given the time window based forest graph, convert each graph component tree to a sequence that can be understood by the large language model. The instructions are further executed by the processor to replace each message with an associated group number obtained from the cosine similarity map. The instructions are further executed by the processor to record beginning and end timestamps of each different sequence to provide a time window view of events in the network or network element. The instructions are further executed by the processor to merge directed trees and occurrence counts. In some embodiments, the instructions are further executed by the processor to organize a query to the large language model prior to providing the representative logs of the different sequences to the large language model by adding additional qualifiers to individual directed trees and recorded time windows. The instructions are further executed by the processor to parse the representative logs of the different sequences at the large language model to identify an issue with the network or network element and controlling operation of the network or network element responsive to the identified issue.

It will be readily apparent to those of ordinary skill in the art that aspects and features of the various described embodiments may be included, omitted, or combined as desired in a given application, without limitation.

### BRIEF DESCRIPTION OF THE DRAWINGS

The present disclosure is illustrated and described with reference to the various drawings, in which like reference numbers are used to denote like assembly components/method steps, as appropriate, and in which:

FIG. 1 is a schematic diagram illustrating one embodiment of the LLM input pre-processing system of the present disclosure;

FIG. 2 is a flowchart illustrating one embodiment of the LLM input pre-processing method of the present disclosure;

FIG. 3 is an example visualization of a flame graph for log sequences mapped to cosine similarity group numbers utilized in conjunction with the LLM input pre-processing system and method of the present disclosure;

FIG. 4 is a schematic diagram illustrating an example processing environment in which the LLM input pre-processing system and method of the present disclosure may be implemented; and

FIG. 5 is a schematic diagram illustrating an example system architecture that may incorporate the LLM input pre-processing system and method of the present disclosure.

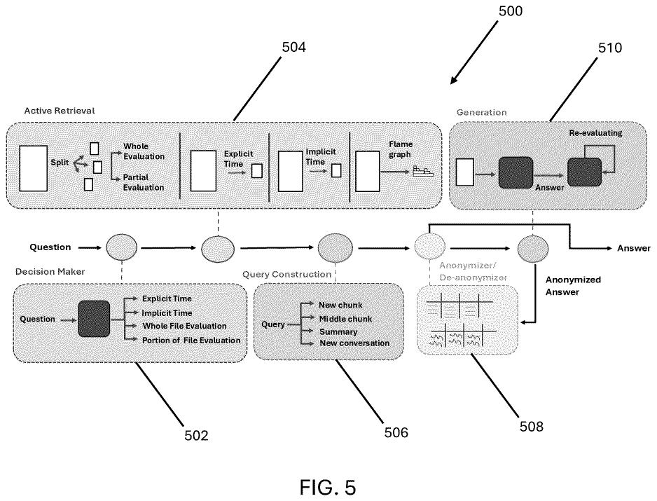

It will be readily apparent to those of ordinary skill in the art that aspects and features of the various illustrated embodiments may be included, omitted, or combined as desired in a given application, without limitation.

### DETAILED DESCRIPTION

Again, the present disclosure provides an automated pipeline that extracts log files and uses in-context learning to adapt an LLM model without extensive retraining. The present disclosure also provides an advantageous approach to accurately responding to developer queries, helping them quickly pinpoint issues within log files while keeping token usage and computational costs manageable. This method enables industries to automate log analysis, reduce system downtime, and improve performance, all while ensuring data privacy and operational efficiency.

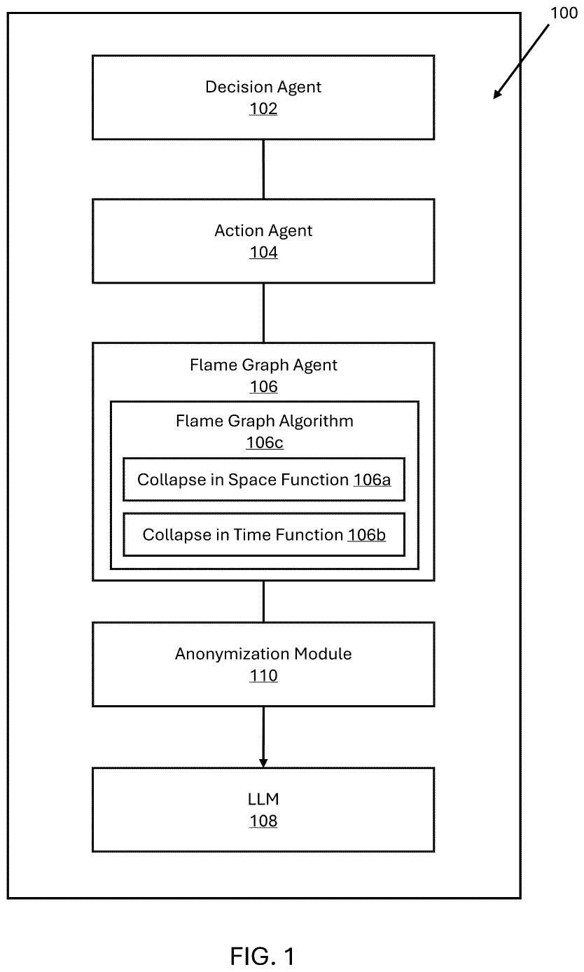

Referring to FIG. 1, as an overview, the LLM input pre-processing system 100 of the present disclosure augments token processing with multiple agents before the LLM process to GPT is initiated. As shown, a decision agent 102 determines a best possible recourse, which could employ a combination of strategies like timestamps, query augmentation, and content splitting. An action agent 104 interacts iteratively with the GPT to obtain the required answer. This may involve feedback of the responses from the GPT back into the next query, leading to more refined answers. Each action is limited by the maximum token size, which is a system constraint for any query. A flame graph agent 106 is based on flame graph techniques well known to those of ordinary skill in the art for function call stack processing of data collection by performance measuring tools on Linux and other systems. The application of such flame graph techniques to collapsing the logs and sequencing of logs to provide a collapsed data set for LLM processing is powerful and reduces the token size by approximately 10×, based on empirical data from sample logs. Of course, the collapsing requires different methods and techniques in the present application, but the basic concept remains the same, as described below.

The flame graph agent 106 performs two main functions, a collapse in space function 106a and a collapse in time function 106b. The collapse in space function 106a uses cosine similarity (a vectorization technique in machine learning (ML)) to group repeated or nearly identical logs together into clusters that are then provided to the LLM 108. This reduces redundancy by ensuring that only one representative log from each cluster is transmitted to the LLM 108. In effect, rather than sending multiple identical logs, the system 100 sends a single compressed version of the message, drastically reducing the number of tokens required. This approach addresses the issue of large logs by focusing on the similarity of logs and minimizing duplication. Once the logs have been grouped, the collapse in time function 106b organizes them based on their temporal sequence. To achieve this, a time window is defined during which logs that occur in close succession are considered part of the same sequence. For example, if two logs occur within a two second window, they are treated as a related sequence and represented hierarchically, like how flame graphs depict call stack in performance profiling. This temporal sequencing step preserves the flow of events. It makes sure that the logs are not only grouped, but are also presented in a manner that reflects their order and timing, thereby preserving the context of the information. By compressing temporally related events into a single representation, the token footprint is further reduced, as fewer individual logs need to be transmitted. In practical terms, multiple error messages occurring within a short time span are compressed into a single event sequence with time annotations. This captures the essential temporal relationships while eliminating redundant entries.

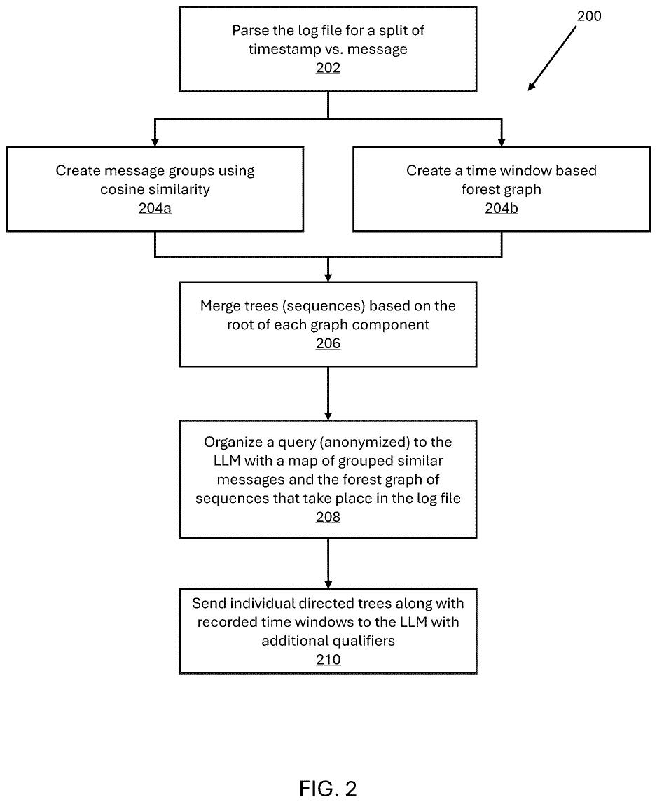

Thus, the flame graph agent uses a flame graph algorithm 106c to create a flame graph equivalent as an input to the LLM 108. Referring to FIG. 2, this LLM input pre-processing method 200 first parses the log file for a split of timestamp vs. message (step 202). For the desired flame graph to be created, it needs to have two fields from every line in the log file, the timestamp and the message. Then, the following two steps are run in parallel, one to create message groups (step 204a) and the other for time window based sequences (step 204b). In step 204a, cosine similarity for natural language processing (NLP), based on the message fields, a cosine similarity algorithm is applied to group messages to create a cosine similarity map of similar messages. In step 204b, a time window based forest graph is created where each graph component is a directed acyclic graph (DAG). The log file is used to create directed trees of logs based on their timestamps, e.g., if the next log is within the time window of the last log, it is appended to that tree, otherwise, it starts a new root stemming another tree. The process 200 continues until the complete log file is parsed. The flame graph algorithm 106c can have many variations, e.g., the time window can be altered to cater to the physical problem.

Then, in step 206, trees (sequences) are merged based on the root of each graph component. With the given forest graph, each component tree is converted to a sequence that can be understood by the LLM 108. Each message is replaced with its group number, which is found in the cosine similarity map for easier comparisons. The beginning and end timestamps of the sequence are recorded for the LLM 108 to have a time window view of the events. Further, the directed trees are merged along with the occurrence counts. The merge operation preserves the directed sub-trees. This step of collapsing the forest graph to a single tree or smaller forest graph yields the flame graph.

Then, in step 208, a query to the LLM 108 is organized with a map of grouped similar messages and the forest graph of sequences that take place in the log file, and, in step 210, the individual directed trees along with recorded time windows are sent to the LLM 108 with additional qualifiers like: “the following sequence of events: “+” message sequence“ +” took place at times “+” time window1“+ . . . ”, each message sequence above is a path in the sequence trees formed as part of the forest graph.

The flame graph built above is based on log sequences within a time window. These can be interpreted as follows. The flame graphs are not representative of any sampling as commonly associated with performance based flame graphs, which are sampled stack trace visualizations. The stack represents the directed tree and thus the log sequence within a specified time window. The head of a sequence seen as the top of a stack in a flame graph represents the last log in the sequence. The width of a stack represents the count of recorded occurrences of a sequence represented by the stack. The forks in a stack represent two log sequences, converging towards the root of the tree. Such a convergence towards the root level avoids the loss of sub-sequences.

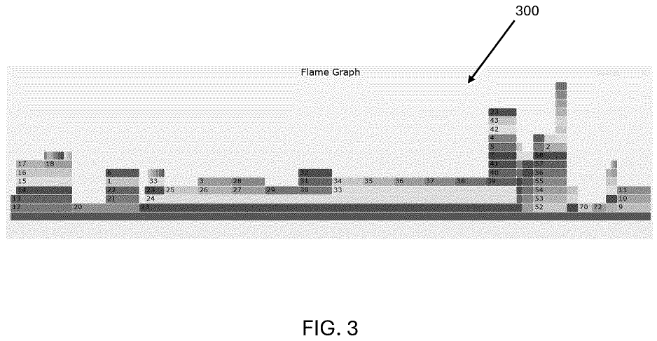

FIG. 3 is an example visualization of a flame graph 300 for log sequences mapped to cosine similarity group numbers. The stacks are representative of log sequences, and the width of stacks represents the occurrences within a log file. The wider flame graph stacks achieve more compression for token size and thus reduce latency. Each number represents a group based on cosine similarity. One can clearly see multiple sequences that could be branched from the same root are easily compressed based on the number of occurrences. There is no information loss since each stack is independently sent over in the form of a LLM query.

As described in greater detail below, the different agents described are advantageously incorporated into the pre-processing pipeline for LLM inputs. The method of augmenting a user query based on looking at clues in the query itself and refining it to either a time bound or data chunked (from one or many files) query is also advantageous, thereby providing more context at less token size. The flame graph method of collapsing using vectorized cosine similarity measures and then also aggregating these groups into higher level groups (hierarchical grouping) to preserve the flow of information, along with the timestamps, is further advantageous. This leads to no loss of information, but provides the lowest possible latency and accurate responses. An anonymization module 110 may be utilized that sanitizes sensitive log data, including Internet protocol (IP) addresses, names, function and module names, and directories, before processing by the LLM 108, while retaining essential information like message content and timestamps for effective analysis. This method 200 improves the F1 score by 138.63% as compared to general mappings, significantly reduces hallucinations, optimizes anonymized data for accurate model interpretation, and restores the original data post-processing. It enables secure, privacy preserving utilization of LLMs on sensitive data without compromising analytical capabilities.

Retrieval augmented generation (RAG) also provides a solution for tokenization challenges by guiding the LLM to extract pertinent information from trusted, predetermined knowledge sources. However, a RAG framework is typically deployed that requires another setup of a large corpus of external databases and has high latency, but which is not extremely helpful in log analysis. Instead of using a database, the framework of the present disclosure employs an inline sub-second processing of data. This also alleviates toke size limitation issues in interaction with LLMs. This method 200 reduces both the token size by approximately 77% to 99.99% and execution latency by approximately 52% to 98% across all logs as compared to the general pipeline approach. The anonymization approach shows an F 1 score improvement of approximately 138.63% over the baseline.

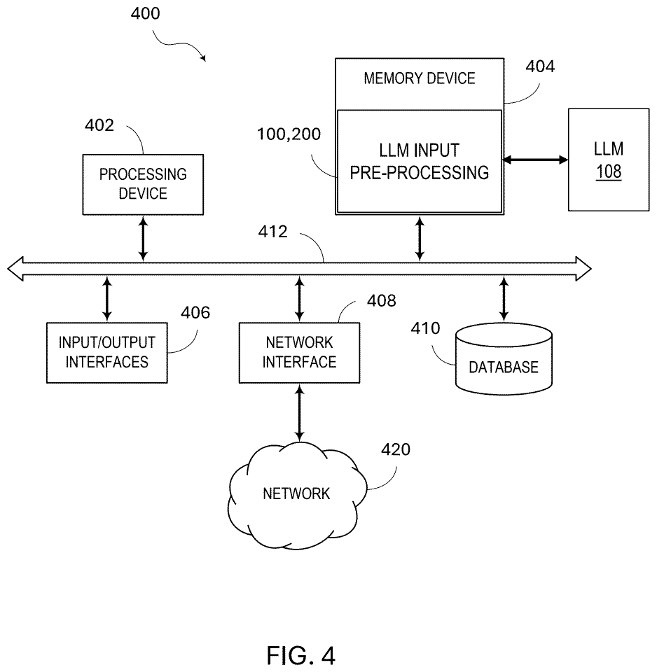

FIG. 4 is a schematic diagram showing an example processing environment 400 in which the LLM input pre-processing system 100 and method 200 of the present disclosure may be implemented. The processing environment 400 generally includes a processing device 402, a memory device 404, input/output (I/O) interfaces 406, a network interface 408, and a database 410. It should be appreciated that the processing environment is illustrated in a simplified manner, where some embodiments may include additional components and suitably configured processing logic to support known or conventional operating features. The components may be communicatively coupled via a local interface 92. The local interface 412 may include, for example, one or more buses or other wired or wireless connections. The local interface 412 may also include controllers, buffers, caches, drivers, repeaters, receivers, among other elements, to enable communication. Further, the local interface 212 may include address, control, and/or data connections to enable appropriate communications among the components.

It should be appreciated that the processing device 402, according to some embodiments, may include or utilize one or more generic or specialized processors (e.g., microprocessors, central processing units (CPUs), digital signal processors (DSPs), network processors (NPs), network processing units (NPUs), graphics processing units (GPUs), field programmable gate arrays (FPGAs), semiconductor-based devices, chips, and/or the like). The processing device 412 may also include or utilize stored program instructions (e.g., stored in hardware, software, and/or firmware) for control of the processing environment 400 by executing the program instructions to implement some or all of the functions of the systems and methods described. Alternatively, some or all functions may be implemented by a state machine that may not necessarily include stored program instructions, may be implemented in one or more application specific integrated circuits (ASICs), and/or may include functions that can be implemented as custom logic or circuitry. Of course, a combination of the aforementioned approaches may be used. For some of the embodiments described, a corresponding device in hardware (and optionally with software, firmware, and combinations thereof) can be referred to as “circuitry” or “logic” that is “configured to” or “adapted to” perform a set of operations, steps, methods, processes, algorithms, functions, techniques, etc., on digital and/or analog signals as described herein with respect to various embodiments.

The memory device 404 may include volatile memory elements (e.g., random access memory (RAM), dynamic RAM (DRAM), synchronous DRAM (SDRAM), static RAM (SRAM), and/or the like), nonvolatile memory elements (e.g., read only memory (ROM), programmable ROM (PROM), erasable PROM (EPROM), electrically erasable PROM (EEPROM), hard drive, tape, compact disc ROM (CD-ROM), and/or the like), and/or combinations thereof. Moreover, the memory device 404 may incorporate electronic, magnetic, optical, and/or other types of storage media. The memory device 404 may have a distributed architecture, where various components are situated remotely from one another, but can be accessed by the processing device 402.

The memory device 404 may include a data store, a database (e.g., database 410), and/or the like, for storing data. In one example, the data store may be located internal to the processing environment 400 and may include, for example, an internal hard drive connected to the local interface 412. Additionally, in another embodiment, the data store may be located external to the processing environment 400 and may include, for example, an external hard drive connected to the I/O interfaces 406. In a further embodiment, the data store may be connected to the processing environment through a network and may include, for example, a network attached file server.

Software stored in the memory device 404 may include one or more programs, each of which may include an ordered listing of executable instructions for implementing logical functions. The software in the memory device 404 may also include a suitable operating system (O/S) and one or more computer programs. The O/S essentially controls the execution of other computer programs, and provides scheduling, input/output control, file and data management, memory management, and communication control and related services. The computer programs may be configured to implement the various processes, algorithms, methods, techniques, etc. described.

Moreover, some embodiments may include non-transitory computer-readable media having instructions stored thereon for programming or enabling a computer, server, processor (e.g., processing device 402), circuit, appliance, device, etc. to perform functions as described. Examples of such non-transitory computer-readable medium may include a hard disk, an optical storage device, a magnetic storage device, a ROM, a PROM, an EPROM, an EEPROM, flash memory, and/or the like. When stored in the non-transitory computer-readable medium, software can include instructions executable (e.g., by the processing device 402 or other suitable circuitry or logic). For example, when executed, the instructions may cause or enable the processing device 402 to perform a set of operations, steps, methods, processes, algorithms, functions, techniques, etc. as described according to the various embodiments.

The methods, sequences, steps, techniques, and/or algorithms described in connection with the embodiments disclosed may be embodied directly in hardware, in software/firmware modules executed by a processor (e.g., processing device 402), or any suitable combination thereof. Software/firmware modules may reside in the memory device 404, memory controllers, double data rate (DDR) memory, RAM, flash memory, ROM, PROM, EPROM, EEPROM, registers, hard disks, removable disks, CD-ROMs, and/or any other suitable storage medium.

Those of ordinary skill in the art will appreciate that various embodiments may be described in terms of logical blocks, modules, circuits, algorithms, steps, and sequences of actions, which may be performed or otherwise controlled with a general purpose processor, a DSP, an ASIC, an FPGA, programmable logic devices, discrete gates, transistor logic, discrete hardware components, elements associated with a computing device, controller, state machine, or any suitable combination thereof designed to perform or otherwise control the functions described.

The I/O interfaces 406 may be used to receive user input from and/or for providing system output to one or more devices or components. For example, user input may be received via one or more of a keyboard, a keypad, a touchpad, a mouse, and/or other input receiving devices. System outputs may be provided via a display device, monitor, user interface (UI), graphical user interface (GUI), a printer, and/or other user output devices. I/O interfaces 406 may include, for example, one or more of a serial port, a parallel port, a small computer system interface (SCSI), an Internet SCSI (iSCSI), an advanced technology attachment (ATA), a serial ATA (SATA), a fiber channel, InfiniBand, a peripheral component interconnect (PCI), a PCI extended interface (PCI-X), a PCI express interface (PCIe), an infrared (IR) interface, a radio frequency (RF) interface, and/or a universal serial bus (USB) interface.

The network interface 408 may be used to enable communication over or with a network 420, the Internet, a wide area network (WAN), a local area network (LAN), and/or the like. The network interface 408 may include, for example, an ethernet card or adapter (e.g., 10BaseT, fast ethernet, gigabit ethernet, 10GbE) or a wireless LAN (WLAN) card or adapter (e.g., 802.11a/b/g/n/ac). The network interface 408 may include address, control, and/or data connections to enable appropriate communications on the network 420.

The network environment 400 includes the LLM input pre-processing system 100 and method 200 of the present disclosure, which may be implemented in hardware, software, or firmware and stored in any suitable non-transitory computer-readable medium (e.g., memory device 404, database 410, and/or the like).

In terms of implementation, the LLM input pre-processing system 100 and method 200 of the present disclosure may be incorporated into an application that allows network or network element logs to be viewed and parsed responsive to natural language (NL) queries and the like from a user, providing context based insight in the GPT responses. Such LLM processing can lead to token limit and latency problems that are solved by the space and time chunking approaches of the present disclosure.

The complexity and size of modern software systems produce massive amounts of logs and logging is now a crucial practice for maintaining software reliability. They can reveal various issues during production, such as hardware failures, misconfigurations, and poor coordination between services. They can also be also used for anomaly detection, failure prediction, and root cause analysis. Since these logs can grow to gigabytes in size, manually reviewing them becomes impractical. Automating log analysis is therefore essential for efficiently identifying and addressing problems. To address these challenges, LLMs have demonstrated considerable potential for automating log analysis processes within software systems. However, despite their capabilities, recent LLMs, which can process large amounts of input data-referred to as the context window-are computationally expensive. This is because they require advanced processing with significant memory capacity to function efficiently. On the other hand, language models struggle to effectively utilize information from long input contexts. Specifically, their performance tends to be best when important information appears at the beginning or end of the input, but drops significantly when the relevant information is located in the middle of long inputs. Therefore, choosing the best context window size is a challenge since it can be costly and directly affect the accuracy of the responses the LLM models produce.

Although, modern LLMs can automate the process of log analysis by processing and interpreting vast amounts of log data, their high computational costs and need for powerful hardware is another challenge. As a result, most companies choose to rely on external services, such as GPT models from OpenAI, to handle these tasks. In addition to the challenges of token limits, context window, and computing costs, dealing with the privacy of log data is another big issue when using LLMs for log analysis. Logs often have sensitive details like IP addresses or user information that need to be handled carefully to follow privacy laws. Using LLMs, especially through third-party services, can risk exposing this private data. Even when running LLMs on local machines, it is important to use data anonymization techniques to keep information safe. So, finding a balance between processing large amounts of logs efficiently and protecting sensitive data is a key challenge in using LLMs for log analysis. This shows the need for solutions that not only reduce token usage but also ensure privacy, which makes LLMs a secure and practical choice for organizations that manage large logs.

The present disclosure provides an adaptive approach to log file analysis using an LLM model. It focuses on solving four main challenges, listed in order of priority as token size limitation, data privacy with minimal loss of accuracy of LLM model responses, context window size tuning for higher accuracy, and prompt engineering for each log type and the chunks within each log. Here, context window size refers to the amount of text the model can consider at once, and tuning it means adjusting this limit to capture all necessary information for accurate responses. Prompt engineering involves designing specific questions or instructions for the model to help it better understand and respond to each type of log.

The LLM input pre-processing system 100 and method 200 of the present disclosure may be utilized with a chatbot that allows users to ask any question related to a log, and the system processes the log to find the answer. Additionally, users can select a specific time range for evaluation. The logs are displayed with a filtering feature, which lets users hide unnecessary or private columns and focus on the desired data.

To help with large log analysis in an industrial setting, an intelligent chatbot may be powered by LLMs and based on existing LLM technology. This approach aims to address the challenges developers and maintenance teams face in identifying root causes within large volumes of log data-especially in complex environments that require knowledge of software architecture and intricate application behaviors. Users can query log files using NL to find errors or issues related to software execution, configuration settings, equipment status, and other unusual events.

FIG. 2 shows an example system architecture 500 that may incorporate the LLM input pre-processing system 100 and method 200 of the present disclosure, utilizing five modules.

A decision maker module 502 processes the user query and determines the appropriate strategy for limiting the number of tokens sent to the LLM. There are four strategies to address token limitations: explicit timestamp, manual time range selection, full content evaluation, and partial content evaluation, as explained below. In general, intent classification is used to determine the type of decision needed for choosing the best portion of the log file. Intent classification is the process of detecting and categorizing user intents in dialogue systems, including both known (seen) and new (unseen) intents, by using methods like capsule based approaches and zero-shot learning to handle the user intents.

For explicit timestamp: If the query includes a timestamp, this module extracts the center time and passes it to the active retrieval system to apply a time windowing approach, centering on the user provided timestamp. Based on expert input, a default 30-second time window is used for analyzing logs, for example, which can be adjusted to make the best use of tokens for each query. This way, only the relevant time frame is sent to the model, reducing token usage. The time window can also be changed depending on the type of log or the specific issue being looked at.

For manual time range selection: Empirical evaluations indicate that developers generally have a clear understanding of the approximate time range of error occurrences, which enables a more efficient and precise examination of relevant log segments. This module provides users with the capability to manually define the desired time window for targeted analysis.

Full or portion of content evaluation: To determine whether a query requires evaluation of the entire log file or just a portion of it, a combination of regular expressions and an LLM based autonomous inference is used. The regular expression captures keywords indicating a need for a full file analysis, such as “how many,” “how much,” “all,” “whole,” “total,” “summary,” and “entire.” For example, if a user asks, “How many errors occurred?” or “Provide a total summary of events,” the regular expression flags this as a query that likely requires examining the whole file. In situations where a query targets specific sections of the log file, such as a recent time frame or a specific type of event, only a portion of the file needs to be evaluated. For instance, if a user asks, “Retrieve CPU usage data for the last 10 minutes” or “What is the status of the most recent log entry?” these queries require targeted information from particular segments rather than a comprehensive analysis. This approach allows for efficient processing by narrowing down the scope to relevant sections instead of analyzing the entire log.

The active retrieval module 504 is responsible to effectively analyze the log files based on the decision of the decision making module 502.

Timestamp strategies: The first strategy involves timestamp based extraction. If a timestamp is explicitly mentioned, the decision making module 502 provides a specific timestamp to the active retrieval module 504, which then extracts logs from a 30-second window surrounding the specified time, for example. Should the user manually select a start and end time, the module focuses on extracting logs within this user defined range. In the absence of specific timestamps, the log file is chunked using a recursive character text splitter.

Portion of content evaluation: For scenarios where only a portion of the log file needs to be analyzed, the most relevant chunks are prioritized using an embedding based technique and calculating the cosine similarity between the query of user and the log file chunks. Based on empirical evidence and trial-and-error optimization, sending the top three most relevant chunks produces more accurate results without exceeding the token limits of the model. Considering resource limitations, several lightweight embedding models may also be tested, with the best being selected.

Full content evaluation: For cases where the entire log file needs to be analyzed, there are two main strategies.

Token count tracking and summarization strategy: For the first strategy, the token limit is tracked. A new conversation for is started each log file the user wants to evaluate. If the token limit is hit, the previous conversation is summarized using text summarization for its prompt a self-prompt technique is used. Then, the summary received from LLM model is sent along with the new chunk of the log file and the query of user to a new conversation. This way, token limits are respected while maintaining the context of the analysis.

Flame graph like strategy: For the second strategy, a flame graph like structure is used to reduce the input tokens in a prompt while keeping most critical contents. Flame graphs have become an essential tool in performance diagnostics by visually representing hierarchical patterns of system activities, making it easier to identify bottlenecks or recurring issues. Inspired by this capability, this method is used for compressing log data to optimize token usage when sending it to LLMs for analysis. The aim is to avoid exceeding token limits by using flame graph like structures to reduce redundancy in the logs. This approach reduces token limitation keeping intact the relationships between logs and events. Instead of sending entire log files, which can be large and redundant, similar sequences of logs are grouped and a flame graph representation is sent that retains both contextual and temporal relationships. This method offers an efficient way to process log data while ensuring that relevant patterns are maintained for LLM based analysis.

The flame graph like approach follows a multi-stage process, described below.

Parsing and grouping log messages by similarity: The process begins by parsing each log entry to extract the timestamp and message fields. To reduce redundancy, log messages are grouped based on their semantic similarity, using cosine similarity to measure how closely messages resemble each other. In large log files, certain types of messages often recur frequently. For instance, error messages like “Error connecting to database” may appear multiple times. Using cosine similarity, repeated or nearly identical logs are grouped together into clusters. This reduces redundancy by ensuring that only one representative log from each cluster is transmitted to the LLM. In effect, rather than sending multiple identical logs, the system sends a single compressed version of the message, drastically reducing the number of tokens required. This approach addresses the issue of large logs by focusing on the similarity of logs and minimizing duplication.

Creating a time windowed forest of DAGs: The log file is used to create directed trees of logs based on their timestamps, e.g., if the next log is within the time window of the last log, it is appended to that tree; otherwise it starts a new root stemming another tree. The process continues until the complete log file is parsed. The algorithm can have many variations, e.g., the time window can be altered to cater to the physical problem.

Merge messages: In this step, each message is replaced by its assigned group number from the first step. For each sequence, consecutive messages with the same group number are merged within the time window, and the start and end times of each merged message are recorded. This step resembles the flame graph approach by aggregating repetitive patterns into a single, compact representation that preserves the timing and structure of events. By aggregating repeated log entries within each sequence and using time ranges, this step achieves a flame graph like structure, compressing each sequence into a concise format. This structure effectively reduces redundancy while maintaining essential information, allowing for efficient analysis and visualization.

In the initial prompt, grouped log messages are sent. Within each group, only the dynamic part of the log message is included, which is the actual message content. Static or redundant parts of the log are discarded, such as timestamps or repetitive metadata. By doing this, the number of tokens used is reduced. Additionally, the full log messages are replaced in the flame graph like structure with their corresponding group numbers. This represents the messages based on the group they belong to. This further reduces the tokens while keeping essential information about the sequence and timing of events.

The flame graph shows sequences of logs within specific time windows. This flame graph is different from traditional flame graphs, which come from sampled stack traces. Here:
Full Log Sequences: Unlike regular flame graphs that use sampling, this flame graph includes complete log sequences within each time window. There is no data loss.
Stacks Represent Log Sequences: Each stack shows a sequence of logs in a time window. It follows the flow of events in that time frame.
Top of the Stack: The top of each stack is the last log in the sequence. This shows where the sequence ends in the time window.
Stack Width and Frequency: The width of a stack shows how many times that sequence appears in the logs. Wider stacks mean the sequence occurs more often, so common patterns stand out.
Forks Show Diverging Sequences: Forks in the stack mean two log sequences meet at the same starting point (or root). This keeps important details in sub-sequences, so unique event paths remain visible.

This flame graph like approach compresses repeated log sequences and organizes them by time windows. It gives a simple but complete view of event patterns, which makes analysis easier and clearer.

Related to the query construction module 506, a self promoting approach is used, where the LLM model was asked to generate various prompts. Each prompt was then assessed on a dataset to identify the one that results in better responses from the LLM.

To efficiently process user queries in log analysis, a tailored prompt framework was developed with several distinct types to address various query needs. The framework operates as follows:
Time-Specific Prompts: If the user manually selects a specific time range, only that selected chunk is sent. However, when a query explicitly mentions a time frame (e.g., between “1 PM and 1:15 PM”), an Explicit Time Prompt focuses on processing logs within that window.
Initial Chunk Evaluation Prompt: For the initial processing, a few-shot prompt is used as a guideline for the model. This prompt includes an explanation of the log file and its types, along with examples tailored to the log file name and type. This information is sent along with the user query and the first chunk for evaluation, whether the task involves analyzing the whole file or selecting the top three chunks.
Extended Evaluation Prompt: For subsequent chunks, a different strategy is used depending on whether the evaluation is for the whole file or partial file. For whole file evaluation, the model is asked to aggregate its previous responses while ensuring uniqueness and eliminating redundancies. For partial evaluation, a specific prompt is used to guide the model in analyzing the relevant chunks individually. For example, if the question is “How many services are down?,” the model analyzes the log file using parameters like module ID and status to identify shut-down services. It then combines relevant responses from previous chunks, ensuring no overlap or duplication in the final result.
Token Limit Management with Summarization: When close to reaching the token limit for a conversation, two prompts are used to handle this condition. The first prompt summarizes all previous responses from previous conversations. The second prompt within a new conversation sends the summary of the previous conversation, user query, and new chunks of log.
Self-Assessment Hallucination Mitigation: Self-assessment prompts are created to guide the model in checking its own responses. These prompts are applied to each response received to reduce the chance of hallucinations and increase the likelihood of relevant answers.
System Prompt (Instructor Prompt): To ensure accurate and well formatted responses, the system prompt is carefully selected based on some empirical studies and user feedback. Additionally, to minimize the chance of hallucinations, chain of thought prompting is incorporated.

As part of the query construction strategy, for each of the prompts, the LLM model is asked to provide suggestions. Evaluation is then limited to a portion of our logs to choose which prompts produced better responses.

To ensure that no critical data is leaked outside the system, an anonymization module 508 is implemented that sanitizes both the log file and the user query. This module anonymizes sensitive data before sending the data to the LLM. After receiving the response from the model, the system reverts the anonymized data back to its original form to preserve the privacy of sensitive data throughout the entire process. A reverse mapping is performed to restore the anonymized items to their original form before displaying them to the user.

Most user queries from logs focus on message content and timestamps. Since timestamps are not considered private data and messages are embedded within functions, this information is crucial for identifying service or function correlations and understanding the sequence of events.

In the generation module 510, communication with the model is managed by sending prompts generated from the query construction process. The total token count is tracked-including both input tokens and model responses-within each conversation. When the maximum token limit is approached, the current conversation is summarized and a new one is initiated to maintain context without exceeding limits. The accuracy of the responses of the model is evaluated through self assessment strategies and all responses are integrated from each chunk to form a complete and accurate answer. In case the response is inaccurate, the module will repeat asking from the active retrieval module for another chunk up to three times, which can be configured.

Although the present disclosure is illustrated and described with reference to illustrative embodiments and examples, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A method for pre-processing input to a large language model to reduce token size, the method comprising
receiving logs from a network or network element,
grouping repeated or similar sequences of logs into clusters with one representative log identified per cluster,
identifying representative logs occurring within a predetermined time window and determining a temporal sequence for the identified representative logs, and
providing the identified representative logs to the large language model with an indication of their temporal sequence to reduce token size.

2. The method of claim 1, wherein the grouping the repeated or similar logs into clusters results in collapsing the logs in space and the identifying the representative logs occurring within the predetermined time window and the determining the temporal sequence for the identified representative logs results in collapsing the logs in time, and further comprising parsing the logs for timestamp and message prior to collapsing the logs in space and collapsing the logs in time.

3. The method of claim 2, wherein
collapsing the logs in space comprises, based on the parsed messages of the logs, applying a cosine similarity algorithm to the logs to create a cosine similarity map of the logs, and
collapsing the logs in time comprises, based on the parsed timestamps of the logs, creating a time window based forest graph of the logs where each graph component is a directed acyclic graph.

4. The method of claim 3, further comprising, given the time window based forest graph, converting each graph component tree to a sequence that can be understood by the large language model.

5. The method of claim 4, further comprising replacing each message with an associated group identifier obtained from the cosine similarity map.

6. The method of claim 5, further comprising recording beginning and end timestamps of different sequences to provide a time window view of events in the network or network element.

7. The method of claim 6, further comprising merging directed trees and occurrence counts.

8. The method of claim 7, further comprising organizing a query to the large language model prior to providing the representative logs of the different sequences to the large language model by adding additional qualifiers to individual directed trees and recorded time windows.

9. The method of claim 1, further comprising parsing the representative logs of different sequences at the large language model to identify an issue with the network or network element and controlling operation of the network or network element responsive to the identified issue.

10. A non-transitory computer-readable medium comprising instructions stored in a memory and executed by a processor to carry out a method for pre-processing input to a large language model to reduce token size, the method comprising
receiving logs from a network or network element,
grouping repeated or similar sequences of logs into clusters with one representative log identified per cluster,
identifying representative logs occurring within a predetermined time window and determining a temporal sequence for the identified representative logs, and
providing the identified representative logs to the large language model with an indication of their temporal sequence to reduce token size.

11. The non-transitory computer-readable medium of claim 10, wherein the grouping the repeated or similar logs into clusters results in collapsing the logs in space and the identifying the representative logs occurring within the predetermined time window and the determining the temporal sequence for the identified representative logs results in collapsing the logs in time, and the method further comprising parsing the representative logs of different sequences at the large language model to identify an issue with the network or network element and controlling operation of the network or network element responsive to the identified issue.

12. A system for pre-processing input to a large language model to reduce token size, the system comprising
a network or network element, and
a memory storing instructions executed by a processor to
receive logs from the network or network element via a network interface,
group repeated or similar sequences of logs into clusters with one representative log identified per cluster,
identify representative logs occurring within a predetermined time window and determine a temporal sequence for the identified representative logs, and
provide the identified representative logs to the large language model with an indication of their temporal sequence to reduce token size.

13. The system of claim 12, wherein the grouping the repeated or similar logs into clusters results in collapsing the logs in space and the identifying the representative logs occurring within the predetermined time window and the determining the temporal sequence for the identified representative logs results in collapsing the logs in time, and wherein the instructions are further executed by the processor to parse the logs for timestamp and message prior to collapsing the logs in space and collapsing the logs in time.

14. The system of claim 13, wherein
collapsing the logs in space comprises, based on the parsed messages of the logs, applying a cosine similarity algorithm to the logs to create a cosine similarity map of the logs, and
collapsing the logs in time comprises, based on the parsed timestamps of the logs, creating a time window based forest graph of the logs where each graph component is a directed acyclic graph.

15. The system of claim 14, wherein the instructions are further executed by the processor to, given the time window based forest graph, convert each graph component tree to a sequence that can be understood by the large language model.

16. The system of claim 15, wherein the instructions are further executed by the processor to replace each message with an associated group identifier obtained from the cosine similarity map.

17. The system of claim 16, wherein the instructions are further executed by the processor to record beginning and end timestamps of different sequences to provide a time window view of events in the network or network element.

18. The system of claim 17, wherein the instructions are further executed by the processor to merge directed trees and occurrence counts.

19. The system of claim 18, wherein the instructions are further executed by the processor to organize a query to the large language model prior to providing the representative logs of the different sequences to the large language model by adding additional qualifiers to individual directed trees and recorded time windows.

20. The system of claim 12, wherein the instructions are further executed by the processor to parse the representative logs of different sequences at the large language model to identify an issue with the network or network element and controlling operation of the network or network element responsive to the identified issue.
